(19) United States
(12) Patent Application Publication
(10) Pub. No.: US 2026/0004641 A1
(43) Pub. Date: Jan. 1, 2026

(54) EVENT-SPECIFIC CRYPTOGRAPHIC TOKENS MODIFIABLE BY CASINO GAMEPLAY

(71) Applicant: IGT, Las Vegas, NV (US)

(72) Inventors: Michael RUSS, Graz (AT); Soheil LATIFI, Brampton (CA)

(73) Assignee: IGT, Las Vegas, NV (US)

(21) Appl. No.: 18/754,926

(22) Filed: Jun. 26, 2024

(51) Int. Cl. G07F 17/32

(52) U.S. Cl. CPC G07F 17/326; G07F 17/3244

(57) ABSTRACT

A system can perform operations to provide and/or maintain event-specific cryptographic tokens that are modifiable by casino gameplay. The operations can include determining an indication of a cryptographic token associated with a player. The cryptographic token can include an indication of access to an event. The operations can further include determining an indication of gameplay by the player. The operations can further include modifying the cryptographic token to adjust the access to the event based on the gameplay by the player.

### BACKGROUND

Embodiments described herein relate to operations in a gaming environment (e.g., provided by a casino) that includes electronic gaming machines (“EGMs”). EGMs can provide one or more games (e.g., wagering games) stored therein that can be played by a player. The EGM can provide a prize to the player based on a wager and an outcome of a wagering game. In some examples, a wagering game includes a slot game in which, in response to receiving a wager from the player, one or more rows of symbols are revealed. A prize can be provided to the player based on the one or more rows of symbols including one or more winning combinations of symbols. In additional or alternative examples, a wagering game includes a table game or a sports book.

### SUMMARY

According to some embodiments, a system is provided. The system includes processing circuitry and memory coupled to the processing circuitry. The memory has instructions stored therein that are executable by the processing circuitry to cause the system to perform operations. The operations include determining an indication of a cryptographic token associated with a player. The cryptographic token includes an indication of access to an event. The operations further include determining an indication of gameplay by the player. The operations further include modifying the cryptographic token to adjust the access to the event based on the gameplay by the player.

According to other embodiments, an electronic gaming machine (“EGM”) is provided. The EGM includes processing circuitry and memory coupled to the processing circuitry. The memory has instructions stored therein that are executable by the processing circuitry to cause the EGM to perform operations. The operations include receiving an indication of a cryptographic token associated with a player. The cryptographic token includes an indication of access to an event. The operations further include providing a wagering game to the player using a game feature based on the access to the event.

According to other embodiments, a method is provided. The method includes determining a cryptographic token associated with a player. The cryptographic token includes an indication of access to a non-gaming event. The method further includes modifying a game feature of a wagering game provided to the player based on the access to the non-gaming event. The method further includes modifying the cryptographic token to adjust the access to the non-gaming event based on gameplay of the wagering game by the player.

According to other embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIG. 3 is a schematic block diagram illustrating various operations for a blockchain token transaction according to some embodiments;

FIG. 4 is a flow chart illustrating an example of operations performed by a system according to some embodiments; and

FIG. 5 is a flow chart illustrating an example of operations performed by an electronic gaming machine according to some embodiments.

### DETAILED DESCRIPTION

Event-specific cryptographic tokens (e.g., non-fungible tokens (“NFTs”)) can preserve access to a specific event for its owner. For example, a cryptographic token may act as a ticket that can be used to gain access to a show. A casino may provide an individual with a cryptographic token including a ticket to access a casino show in an attempt to encourage the individual to take part in other casino activities (e.g., wagering). However, a cryptographic token may be static such that it only grants the pre-defined benefit (e.g., the ticket only encourages the individual to attend the show).

Various embodiments herein describe event-specific cryptographic tokens that are modifiable based on other activities (e.g., casino gameplay). In some embodiments, an event-specific cryptographic token can be modified such that corresponding rights respective to the event are modified (e.g., upgraded). In some examples, a cryptographic token may initially be associated with general admission to a concert and may be modified, in response to a threshold amount of gameplay, to be associated with a VIP (e.g., backstage) access to the concert. This can incentivize individuals attending an event to partake in other casino activities. In additional or alternative embodiments, EGMs can modify the game features they provide based on being provided an indication of an cryptographic token. In some examples, a cosmetic or functional aspect of a wagering game may be modified based on a player owning a cryptographic token that includes an indication of access to an event.

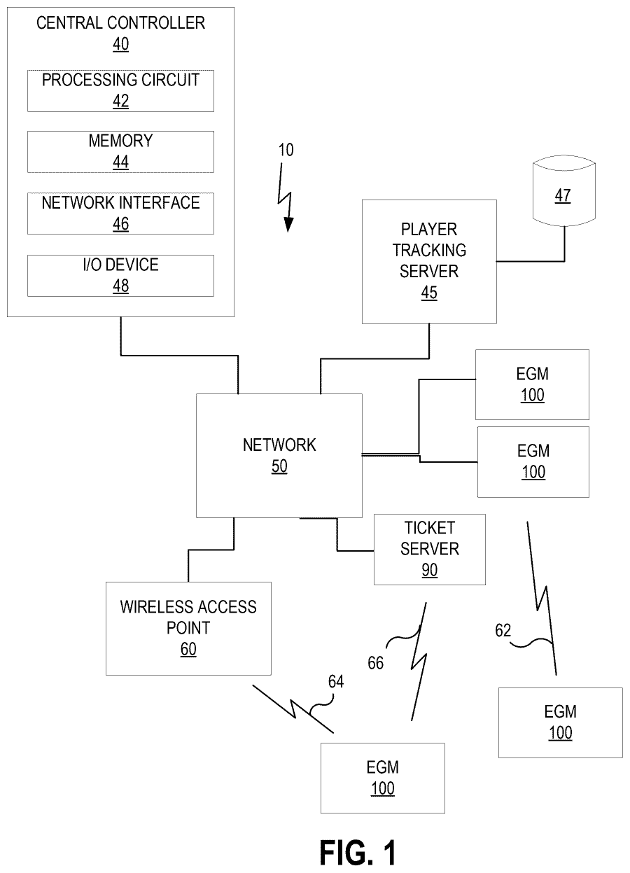

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

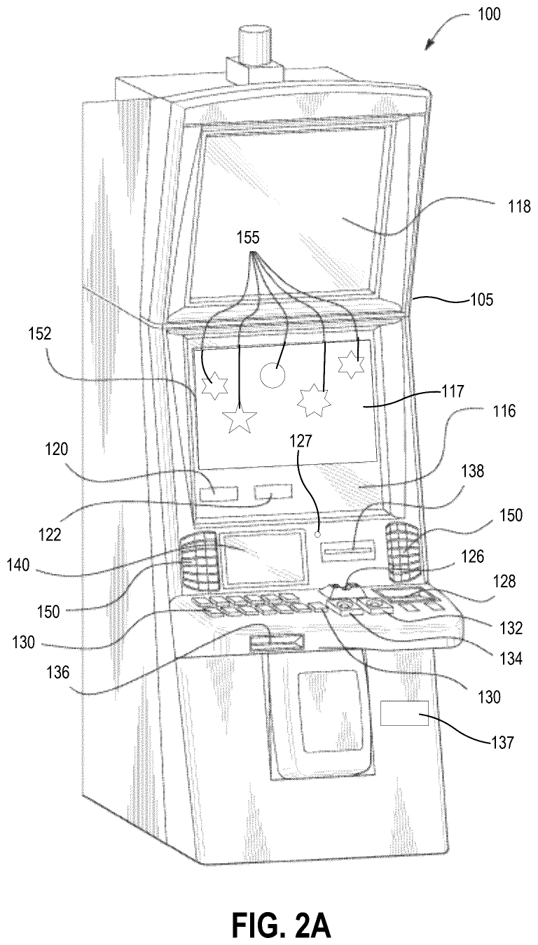

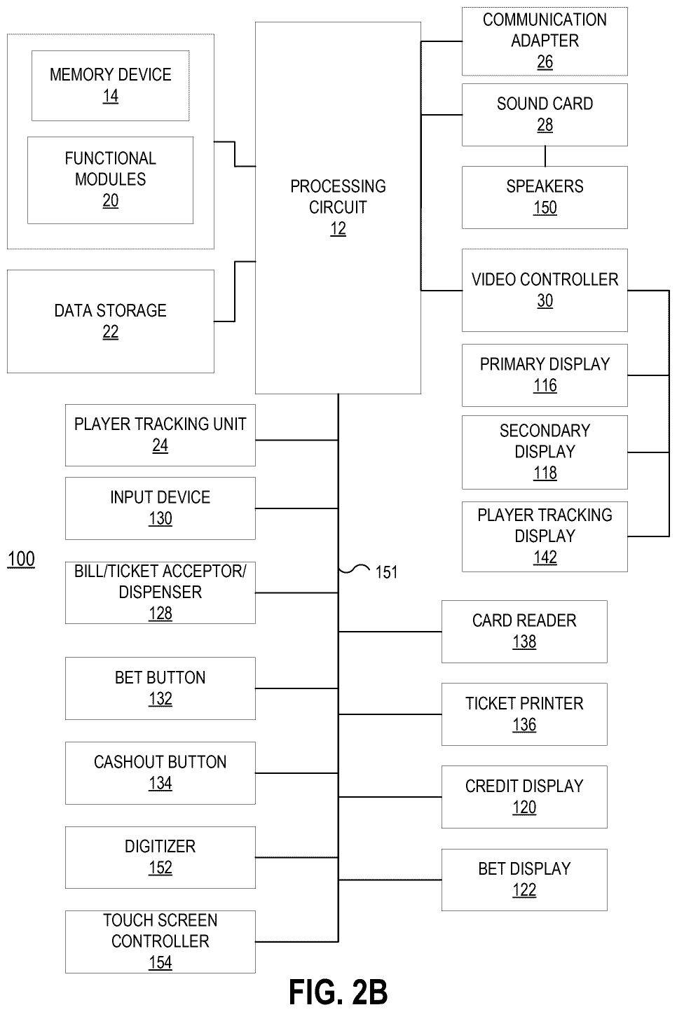

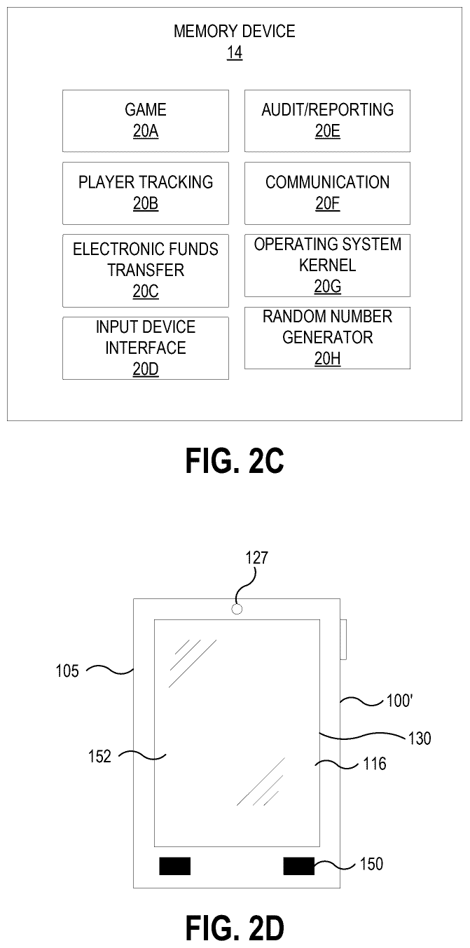

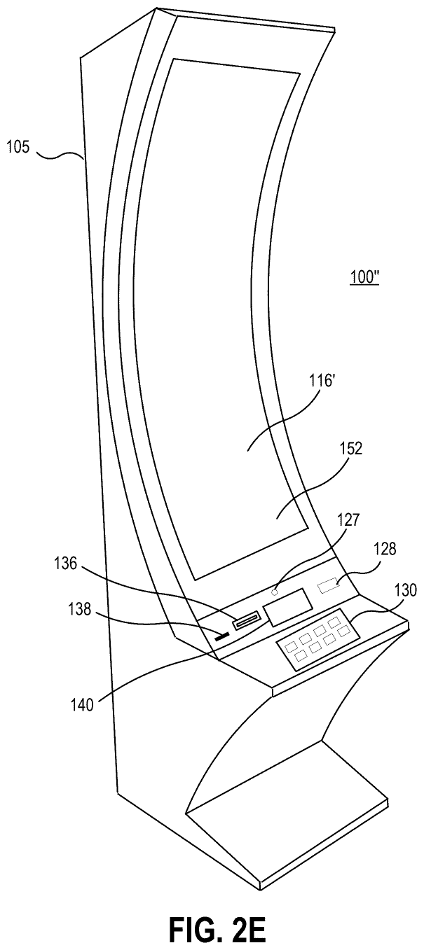

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

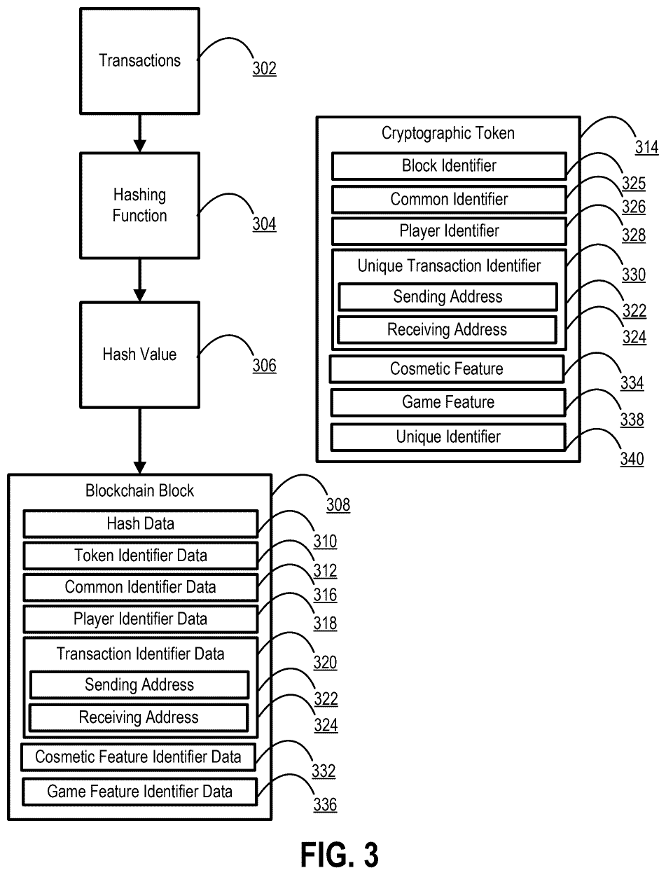

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include cosmetic feature identifier data 332 associated with a cosmetic feature 334, such as a stored graphical image and/or a graphical modification of a game element of a wagering game. Each block 308 may further include game feature identifier data 336 associated with a game feature 338 for redeeming a portion of a non-monetary credit amount as a monetary award amount. Each cryptographic token 314 may be a fungible token that is fungible with other cryptographic tokens, and/or may further include a unique identifier 340, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

Various embodiments herein describe event-specific cryptographic tokens that interact with other activities that are independent from the event (e.g., activities at a casino where the event is being held). In some embodiments, a player obtains an event-specific cryptographic token in order to be granted an initial level of access to an event. The level of access can be improved and/or expanded based on the other activities (e.g., casino gameplay). In additional or alternative embodiments, by providing an indication that the player has access to the event (e.g., by providing an indication of the cryptographic token), game features associated with casino gameplay can be modified. In some examples, a player of an EGM may own a cryptographic token that provides access to a formula one race. In response to providing an indication of the cryptographic token to the EGM, the EGM may alter a graphical element of a wagering game provided by the EGM to be associated with the formula one race.

In some embodiments, a gaming system (e.g., system 10 of FIG. 1) may support NFTs and blockchain-based gameplay. In some examples, a player may keep cryptographic tokens in a virtual wallet accessible by the system. The event-specific cryptographic tokens can be verified on a blockchain, that grant specific rights/functionality at specific events. Such events could be events taking place in a casino (e.g., an actor or a singer) or it could be casino-specific (gaming-related) events.

In additional or alternative embodiments, event-specific cryptographic tokens can be of different tiering. In some examples, a high tier “VIP token” can grant more rights than a low tier “Regular token.” This can be relevant in the event itself and before or after the event. In additional or alternative embodiments, event-specific cryptographic tokens can be purchased, traded, or won (completely random or based on status/game play).

In additional or alternative embodiments, event-specific cryptographic tokens can be enhanced prior to the event, for example, by gameplay in the casino while having the event cryptographic token enabled. By doing so, a “low tier event token” might be upgraded to a “high tier event token” based on game play. The cryptographic token can be stored in the player's crypto wallet. In some examples, casino games request an indication of a cryptographic token to be activated (e.g., to associate game play with).

In some examples, an event-specific cryptographic token is gained by the player (e.g., purchased, won, or traded. The event-specific cryptographic token may start as a “Regular token” for the specific event. Ownership of that event-specific cryptographic token grants the owner “regular” benefits (e.g., eligibility to the event, regular seat). When activating that event-specific cryptographic token during gameplay, by playing, the event-specific cryptographic token is making progress. Once a gameplay threshold is reached, the “Regular token” turns into a “VIP token” that grants the player VIP benefits (e.g., no entrance fee to the event, plus VIP seats).

In additional or alternative embodiments, a system (either decentralized or operated by the casino) tracks game play with the “activated” token. Once a threshold is reached (e.g., a number of spins played), the event-specific cryptographic token will automatically upgrade in the player's wallet.

In some embodiments, a progress indicator can be provided indicating a cryptographic token's progress towards being modified. In some examples, an EGM can provide a visual indicator (e.g., a progress bar that fills during gameplay). Once the bar is full, the event-specific cryptographic token can be upgraded to a next level. In additional or alternative examples, upgrading the event-specific cryptographic token may include requiring a user decision (e.g., a selection of one improvement of a number of potential improvements). The user decision may include a selection as part of an evolution tree (e.g., point earned from gameplay may be used to evolve the cryptographic token based on a path through a tree structure of different improvements.

In additional or alternative embodiments, a non-event cryptographic token can become an event-specific cryptographic token based on gameplay. In some examples, a player can earn a traditional token (e.g., a cosmetic NFT without any function). Next, the game or the player's crypto wallet can indicate that this traditional token has the ability to become an event-specific cryptographic token by upgrading it based on gameplay. In additional or alternative examples, a player can define, once a traditional token is ready to become an event-specific cryptographic token, which specific event it should provide access to. Upon doing so, the player would gain the benefits for the chosen event. In additional or alternative embodiments, an event-specific cryptographic token can become a multi-event cryptographic token that grants access to multiple different events. In some examples, multiple event-specific cryptographic tokens can be merged into a multi-event cryptographic token.

Based on gameplay, an event-specific cryptographic token can be upgraded according to personal preferences, granting player-defined benefits for and/or after the event. In some embodiments, the event-specific cryptographic token can modify game features of a wagering game based on the level of access and/or the type of event associated with the event-specific cryptographic token. In some examples, if it is a Wheel-of-Fortune related event, then all Wheel-of-Fortune games may support the token modification feature ability and may adjust a pay table associated with the game in response to being provided an indication of a cryptographic token. In additional or alternative examples, if there is a Madonna event upcoming, then several (or all) games in the venue would temporarily get Madonna-assets integrated into the game.

In some embodiments, the gameplay is associated with a slot game, a table game, or a sports wager. In additional or alternative embodiments, progress towards a threshold amount of gameplay is linear and step-wise. In additional or alternative embodiments, progress towards the threshold amount of gameplay can depend on environmental factors (e.g., spatial or temporal proximity to the event), or a type of game play (e.g., free spins may gain a different number of points than wagered spins of a slot machine). In additional or alternative embodiments, the threshold amount of gameplay may require gameplay by other players. In some examples, the threshold amount of gameplay includes a gameplay goal being simultaneously met on three linked EGMs. In additional or alternative embodiments, the threshold amount of gameplay may require reoccurring gameplay. In some examples, upgrades to a cryptographic token are not permanent, for example, they may require maintaining or repeating an amount of gameplay.

Event-specific cryptographic tokens can also be traded and can have a predetermined resell license fee included for every transaction from the owner to the buyer. For example, 2% of the resell price would go to the operator and another 2% would go to the actor themselves. Thus, both operator and actor would benefit from an event-specific cryptographic token being traded.

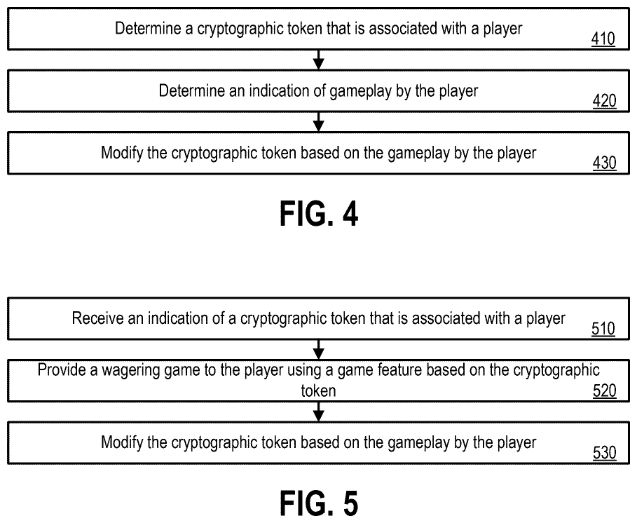

FIG. 4 illustrates examples of operations performed by a system according to some embodiments. Although the operations will be described in regards to processing circuit 42 of a central controller 40, the operations can be performed by any suitable system and/or any device within a system.

At block 410, processing circuit 42 determines a cryptographic token that is associated with a player. In some embodiments, the cryptographic token includes an indication of access to an event. In some examples, the access to the event includes event entrance, event seat, welcome offers, special treatment, take a picture with actor, drinks, or meals.

In additional or alternative embodiments, processing circuit 42 receives an identifier of the player from an EGM that provides a wagering game to the player. In some examples, determining the indication of the cryptographic token includes retrieving the cryptographic token from a virtual wallet associated with the identifier of the player. In additional or alternative examples, determining the indication of the gameplay by the player includes receiving an indication of the gameplay by the player from the EGM providing the wagering game to the player.

At block 420, processing circuit 42 determines an indication of gameplay by the player.

At block 430, processing circuit 42 modifies the cryptographic token based on the gameplay by the player. In some examples, access to the event includes a first level of access to the event. Modifying the cryptographic token includes replacing the first level of access with a second level of access to the event based on the gameplay. In additional or alternative examples, modifying the cryptographic token includes determining that there is availability of the second level of access to the event.

In additional or alternative embodiments, modifying the cryptographic token includes determining that the gameplay includes a threshold amount of gameplay of a specific wagering game within a period of time associated with a time of the event. Modifying the cryptographic token can further include adjusting the access to the event based on determining that the gameplay comprises a threshold amount of gameplay of a specific wagering game within a period of time associated with a time of the event.

In some embodiments, processing circuit 42 transmits an indication to a device associated with the player indicating that performance of the gameplay by the player will result in the access be modified (e.g., an indication that the first level of access with the second level of access to the event).

In some embodiments, processing circuit 42 transmits instructions to modify a game feature associated with a wagering game being provided to the player based on the cryptographic token.

Various operations from the flow chart of FIG. 4 may be optional with respect to some embodiments systems and related methods.

FIG. 5 illustrates examples of operations performed by an EGM according to some embodiments. Although the operations will be described in regards to processing circuit 12 of an EGM 100, the operations can be performed by any suitable EGM or gaming device.

At block 510, processing circuit 12 receives an indication of a cryptographic token associated with a player. In some embodiments, the cryptographic token includes an indication of access to an event. In some examples, the event includes a real-world event or an in-game event.

At block 520, processing circuit 12 provides a wagering game to the player using a game feature based on the cryptographic token (and/or its corresponding access to the event). In some examples, the indication of access to the event includes an indication that the cryptographic token has been used to access the event. Providing the wagering game to the player using the game feature includes using a specific game feature based on the cryptographic toke having been used to access the event.

In additional or alternative examples, the indication of access to the event includes an indication that the cryptographic token has not been used to access the event. Providing the wagering game to the player using the game feature includes using a specific game feature based on the cryptographic toke having not been used to access the event.

In additional or alternative examples, the indication of access to the event includes an indication of an access level to the event. Providing the wagering game to the player using the game feature includes using a specific game feature based on the access level to the event.

In additional or alternative examples, providing the wagering game to the player using the game feature includes modifying a cosmetic element of the wagering game based on the access to the event.

In additional or alternative examples, providing the wagering game to the player using the game feature includes modifying a payout of the wagering game based on the access to the event.

In additional or alternative examples, providing the wagering game to the player using the game feature includes using a specific game feature based on an outcome of the event.

In additional or alternative examples, providing the wagering game to the player using the game feature includes using a specific game feature based on a current time relative to a time of the event.

In additional or alternative examples, providing the wagering game to the player using the game feature includes displaying an indicator of an amount of gameplay required by the player to improve an access level of the access to the event.

At block 530, processing circuit 12 modifies the cryptographic token to adjust the access to the event based on gameplay by the player. In some embodiments, modifying the cryptographic token includes increasing a value of the access to the event based on gameplay by the player.

Various operations from the flow chart of FIG. 5 may be optional with respect to some embodiments of EGMs and related methods.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
processing circuitry; and
memory coupled to the processing circuitry and having instructions stored therein that are executable by the processing circuitry to cause the system to perform operations comprising:
determining an indication of a cryptographic token associated with a player, the cryptographic token comprising an indication of access to an event;
determining an indication of gameplay by the player; and
modifying the cryptographic token to adjust the access to the event based on the gameplay by the player.

2. The system of claim 1, the operations further comprising:
receiving an identifier of the player from an electronic gaming machine (“EGM”) providing a wagering game to the player,
wherein determining the indication of the cryptographic token associated with the player comprises retrieving the indication of the cryptographic token from a virtual wallet associated with the identifier of the player.

3. The system of claim 1, wherein determining the indication of the gameplay by the player comprises receiving an indication of the gameplay by the player from an electronic gaming machine (“EGM”) providing a wagering game to the player.

4. The system of claim 1, wherein the access to the event comprises a first level of access to the event, and
wherein modifying the cryptographic token comprises replacing the first level of access with a second level of access to the event based on the gameplay.

5. The system of claim 4, the operations further comprising:
determining that there is availability of the second level of access to the event; and
transmitting an indication to a device associated with the player indicating that performance of the gameplay by the player will result in replacing the first level of access with the second level of access to the event.

6. The system of claim 1, wherein modifying the cryptographic token comprises:
determining that the gameplay comprises a threshold amount of gameplay of a specific wagering game within a period of time associated with a time of the event; and
modifying the cryptographic token to adjust the access to the event based on determining that the gameplay comprises a threshold amount of gameplay of a specific wagering game within a period of time associated with a time of the event.

7. The system of claim 1, the operations further comprising:
transmitting instructions to modify a game feature associated with a wagering game being provided to the player based on the cryptographic token.

8. An electronic gaming machine (“EGM”) comprising:
processing circuitry; and
memory coupled to the processing circuitry and having instructions stored therein that are executable by the processing circuitry to cause the EGM to perform operations comprising:
receiving an indication of a cryptographic token associated with a player, the cryptographic token comprising an indication of access to an event; and
providing a wagering game to the player using a game feature based on the access to the event.

9. The EGM of claim 8, wherein the indication of access to the event comprises an indication that the cryptographic token has been used to access the event, and
wherein providing the wagering game to the player using the game feature comprises using a specific game feature based on the cryptographic toke having been used to access the event.

10. The EGM of claim 8, wherein the indication of access to the event comprises an indication that the cryptographic token has not been used to access the event, and
wherein providing the wagering game to the player using the game feature comprises using a specific game feature based on the cryptographic toke having not been used to access the event.

11. The EGM of claim 8, wherein the indication of access to the event comprises an indication of an access level to the event, and
wherein providing the wagering game to the player using the game feature comprises using a specific game feature based on the access level to the event.

12. The EGM of claim 8, wherein the event comprises a real-world event.

13. The EGM of claim 8, wherein the event comprises an in-game event.

14. The EGM of claim 8, wherein providing the wagering game to the player using the game feature comprises modifying a cosmetic element of the wagering game based on the access to the event.

15. The EGM of claim 8, wherein providing the wagering game to the player using the game feature comprises modifying a payout of the wagering game based on the access to the event.

16. The EGM of claim 8, wherein providing the wagering game to the player using the game feature comprises using a specific game feature based on an outcome of the event.

17. The EGM of claim 8, wherein providing the wagering game to the player using the game feature comprises using a specific game feature based on a current time relative to a time of the event.

18. The EGM of claim 8, wherein providing the wagering game to the player using the game feature comprises displaying an indicator of an amount of gameplay required by the player to improve an access level of the access to the event.

19. The EGM of claim 8, the operations further comprising:
modifying the cryptographic token to increase a value of the access to the event based on gameplay by the player.

20. A method comprising:
determining a cryptographic token associated with a player, the cryptographic token comprising an indication of access to a non-gaming event;
modifying a game feature of a wagering game provided to the player based on the access to the non-gaming event; and
modifying the cryptographic token to adjust the access to the non-gaming event based on gameplay of the wagering game by the player.
